(19) United States
(12) Patent Application Publication
(10) Pub. No.: US 2022/0229157 A1
(43) Pub. Date: Jul. 21, 2022

(54) LIDAR SENSOR FOR OPTICALLY DETECTING A FIELD OF VIEW AND METHOD FOR OPTICALLY DETECTING A FIELD OF VIEW

(71) Applicant: Robert Bosch GmbH, Stuttgart (DE)

(72) Inventors: Hans-Jochen Schwarz, Stuttgart (DE); Anne Schumann, Korntal-Muenchingen (DE); Horst Beling, Heilbronn (DE); Klaus Stoppel, Mundelsheim (DE); Marco Naegele, Stuttgart (DE); Martin Kastner, Bietigheim-Bissingen (DE)

(21) Appl. No.: 17/608,042

(22) PCT Filed: May 15, 2020
(86) PCT No.: PCT/EP2020/063572

§ 371 Date: Nov. 1, 2021

(30) Foreign Application Priority Data
May 22, 2019 (DE) 10 2019 207 470.7

(51) Int. Cl. G01S 7/481; G01S 17/89; G01S 13/931

(52) U.S. Cl. CPC G01S 7/4812; G01S 7/4818; G01S 7/4817; G01S 13/931; G01S 7/4814; G01S 17/89

(57) ABSTRACT

A LIDAR sensor for optically detecting a field of view. The LIDAR sensor includes an emission unit for emitting primary light into the field of view and a receiving unit for receiving secondary light, which was reflected and/or scattered in the field of view by an object. The emission unit includes: a light source for generating the primary light; a plate-shaped light guide optics including a beam exit for guiding the generated primary light; and at least one emission optics for emitting the guided primary light into the field of view. The receiving unit includes: at least one receiving optics for receiving secondary light; at least two optical fibers, each including a beam entrance for guiding the received secondary light; and at least one detector unit for detecting the guided secondary light. The emission optics and the receiving optics are situated coaxially to one another.

### FIELD

The present invention relates to a LIDAR sensor for optically detecting a field of view, in particular for a working device, a vehicle, or the like, and to a method for optically detecting a field of view.

### BACKGROUND INFORMATION

German Patent Application No. DE 10 2016 213 348 A1 describes an optical system for a LIDAR system for optically detecting a field of view, in particular for a working device or for a vehicle, including an receiver optics designed in a segmented manner including an—in particular odd-numbered—plurality of optically imaging segments, in which the optically imaging segments of the receiver optics are situated next to one another.

### SUMMARY

The present invention is directed to a LIDAR sensor for optically detecting a field of view. In accordance with an example embodiment of the present invention, the LIDAR sensor includes an emission unit for emitting primary light into the field of view and a receiving unit for receiving secondary light, which was reflected and/or scattered in the field of view by an object. Here, the emission unit includes a light source for generating the primary light; a plate-shaped light guide optics including a beam exit for guiding the generated primary light; and at least one emission optics for emitting the guided primary light into the field of view. The receiving unit includes at least one receiving optics for receiving secondary light; at least two optical fibers, each including a beam entrance for guiding the received secondary light; and at least one detector unit for detecting the guided secondary light.

According to the present invention, the emission optics and the receiving optics are situated coaxially to one another.

With the aid of a LIDAR sensor, a distance between the LIDAR sensor and an object in the field of view of the LIDAR sensor may be directly or indirectly determined on the basis of a time of flight (TOF). With the aid of a LIDAR sensor, a distance between the LIDAR sensor and an object in the field of view of the LIDAR sensor may be determined, for example, on the basis of pulsed light, on the basis of a phase-modulated continuous wave signal, or on the basis of a frequency-modulated continuous wave (FMCW) signal.

The field of view of the LIDAR sensor may be scanned with the aid of the emitted primary light. The extension of the field of view may be predefined here by a first angular range and a second angular range, and by a range of the primary light. The primary light may be output and received again, for example, at different scanning angles of the field of view. An image of the surroundings may be subsequently derived from such angle-dependent individual measurements. The emission of the primary light at different scanning angles may take place with the aid of a rotatable and/or pivotable deflection unit. The deflection unit may be a mirror, which is rotatable and/or pivotable about a rotation axis.

The LIDAR sensor optionally includes at least one evaluation unit. The received secondary light may be evaluated with the aid of the evaluation unit. The result of the evaluation may be utilized, for example, for a driver assistance function of a vehicle. The result of the evaluation may be utilized, for example, for controlling an autonomously driving vehicle. The LIDAR sensor may be designed, in particular, for the utilization in an at least semi-autonomously driving vehicle. With the aid of the LIDAR sensor, semi-autonomous or autonomous travel of vehicles on expressways and/or in city traffic may be implemented.

The light source of the emission unit may be designed as at least one laser unit. The laser unit may be designed as an edge emitter, a surface laser, or a solid body laser. An edge emitter may be designed as a broad area laser or a laser bar. A laser bar may also be designed as a multi-bar laser. In a multi-bar laser, at least two single laser bars may be soldered on top of one another. As a result, a higher power may be achieved at the exit surface of the light source. A surface laser may be designed as a vertical cavity surface emitting laser (VCSEL) or as a vertical external cavity surface emitting laser (VeCSEL). A vertical cavity surface emitting laser or a vertical external cavity surface emitting laser may be designed in alignment or as a line array (including multiple, for example, 50, emitters) or as a 2-dimensional array including a smaller number of emitters in the one propagation direction than in the other propagation direction (for example, 2×50 emitters). In the latter variant, a higher power may be achieved at the exit surface of the light source. Preferably, the light source is designed as a line laser. It is particularly preferred when a line laser is designed as an edge emitter bar.

The plate-shaped light guide optics may be understood to be an optical printed board. In accordance with an example embodiment of the present invention, the plate-shaped light guide optics may include a plate base body and at least one fiber situated thereon. A fiber situated on the plate base body may include at least one coupling end for coupling the primary light generated by the light source. A fiber situated on the plate base body may include at least one decoupling end for decoupling guided primary light. The at least one decoupling end of the at least one fiber may form the beam exit of the plate-shaped light guide optics. The plate-shaped optical fiber may be designed as a composite made up of fibers.

The emission optics may include at least one optical element. The receiving optics may include at least one optical element. An optical element may be, for example, an optical lens, an optical filter, a beam splitter, a mirror, or the like. The fact that the emission optics and the receiving optics are situated coaxially to one another may be understood, for example, to mean that the emission optics and the receiving optics are situated along a shared optical axis. The emission optics and the receiving optics may include a shared optical element.

The at least two optical fibers may each be designed as a light guide. The optical fibers each include a beam entrance for coupling the received secondary light. The optical fibers may each include a decoupling end for decoupling guided secondary light. The at least two optical fibers may be designed as a composite made up of optical fibers.

In accordance with an example embodiment of the present invention, the plate-shaped light guide optics and the at least two optical fibers may be situated next to one another. The plate-shaped light guide optics and the at least two optical fibers may be hot-pressed. The plate-shaped light guide optics and the at least two optical fibers may be glued. An adhesive utilized for this purpose may have a predefined refractive index. The plate-shaped light guide optics and the at least two optical fibers may be situated symmetrically with respect to one another. The plate-shaped light guide optics may be arranged, for example, between the at least two optical fibers for this purpose. As a result, secondary light may be more efficiently received. The plate-shaped light guide optics and the at least two optical fibers may be situated asymmetrically with respect to one another. The plate-shaped light guide optics may be arranged, for example, on a side next to the at least two optical fibers for this purpose. As a result, the LIDAR sensor may be manufactured with less production expenditure. The LIDAR sensor may be more cost-effectively configured.

An advantage of the present invention is that the LIDAR sensor needs a smaller installation space. Due to the plate-shaped light guide optics, a more flexible installation space configuration may be enabled. Due to the at least two optical fibers, a more flexible installation space configuration may be enabled. The alignment of the emission unit and the receiving unit with respect to one another is more easily possible. It requires few adjustment steps.

In one advantageous embodiment of the present invention, it is provided that the plate-shaped light guide optics may include at least one fiber bundle. The advantage of this embodiment is that the fiber bundle is flexibly adaptable to the geometry of the light source. In this way, each fiber of the fiber bundle may include a coupling end for coupling the primary light generated by the light source and a decoupling end for decoupling guided primary light. The coupling ends may be flexibly adaptable to the geometry of the light source. In this way, the coupling ends may be, for example, linearly situated when the light source is linearly designed. However, if the light source is designed, for example, to be planar, the coupling ends of the fiber bundle may have an arrangement suitable for coupling primary light generated by this planar light source. The decoupling ends may be linearly situated in both examples.

In one advantageous embodiment of the present invention, it is provided that the at least two optical fibers are situated in a curved manner. The advantage of this embodiment is that the placement of the detector unit is freely selectable. The detector unit may be placed in various ways with respect to the light source. This has advantages with respect to the cooling of the detector unit and the electromagnetic compatibility.

In one further advantageous embodiment of the present invention, it is provided that the plate-shaped light guide optics is designed in such a way that the generated primary light is mixable. For this purpose, the plate-shaped light guide optics may be designed to be curved. The advantage of this embodiment is that a more homogeneous illumination of the field of view may be implemented. Eye safety may be improved. In addition, the failure of a single emitter of the light source is reflected only as a decrease in the overall intensity. In this case, all image points may nevertheless continue to be illuminated.

In one further advantageous embodiment of the present invention, it is provided that the generated primary light is mixable in at least two subareas of the plate-shaped light guide optics situated separately from one another. The advantage of this embodiment is that the primary light may have different optical properties in each of the various subareas. Primary light having different optical properties may be mixed in the subareas separately from one another.

In one further advantageous embodiment of the present invention, it is provided that generated primary light of at least two wavelengths, which differ from one another, is guidable to the beam exit with the aid of the plate-shaped light guide optics. Here, the generated primary light is mixable in at least two subareas of the plate-shaped light guide optics situated separately from one another. The advantage of this embodiment is that, in the field of view, for example, one row may be illuminated with the aid of different wavelengths. This is advantageous in order to simulate the angle dependence of a receiving filter. This has advantages for eye safety, a more homogeneous illumination of the field of view may be implemented, and the failure of a single emitter of the light source is reflected only as a decrease in the overall intensity. In this case, all image points may nevertheless continue to be illuminated.

In one further advantageous embodiment of the present invention, it is provided that the beam exit of the plate-shaped light guide optics has a taper. The advantage of this embodiment is that the surface portion of the emission optics is smaller. This has a favorable effect on the portion of the primary light at the detector.

A coupling end of an optical fiber situated on the plate base body may also have a taper. A beam entrance of the plate-shaped light guide optics may also have a taper. As a result, more light power of the generated primary light may be captured.

In one further advantageous embodiment of the present invention, it is provided that each of the at least two optical fibers have a taper at one decoupling end. As a result, the surface area of the optical fibers may be better adapted to the surface area of the detector unit.

In one further advantageous embodiment of the present invention, it is provided that the beam exit of the plate-shaped light guide optics is designed as a rod lens structure. For this purpose, the beam exit of the plate-shaped light guide optics may have been, for example, fused. For this purpose, the rod lens structure may be, for example, glued on. The advantage of this embodiment is that the beam exit of the plate-shaped light guide optics and the beam entrance of the at least two optical fibers may be formed in such a way that more secondary light enters the optical fibers.

In one further advantageous embodiment of the present invention, it is provided that the refractive index of the plate-shaped light guide optics is smaller than the refractive index of the at least two optical fibers. The advantage of this embodiment is that primary light may pass over from the plate-shaped light guide optics may into the optical fibers. Conversely, the pass-over is less likely, however, due to intensified total reflection.

The present invention is also directed to a method for optically detecting a field of view with the aid of a LIDAR sensor, the LIDAR sensor including an emission unit for emitting primary light into the field of view and a receiving unit for receiving secondary light, which was reflected and/or scattered in the field of view by an object. In accordance with an example embodiment of the present invention, the method includes the steps of generating the primary light with the aid of a light source; guiding the primary light with the aid of a plate-shaped light guide optics including a beam exit; emitting the guided primary light into the field of view with the aid of at least one emission optics; receiving secondary light with the aid of at least one receiving optics; guiding the received secondary light with the aid of at least two optical fibers with the aid of one beam entrance in each case; and detecting the guided secondary light with the aid of at least one detector unit. The emission optics and the receiving optics are situated coaxially to one another.

### BRIEF DESCRIPTION OF THE DRAWINGS

Exemplary embodiments of the present invention are explained in greater detail below with reference to the figures. Identical reference numerals in the figures designate identical or identically acting elements.

FIG. 1A shows a top view of one exemplary embodiment of a LIDAR sensor, in accordance with the present invention.

FIG. 1B shows a side view of the exemplary embodiment from FIG. 1A, in accordance with the present invention.

FIG. 2 shows a side view of one further exemplary embodiment of a LIDAR sensor, in accordance with the present invention.

FIG. 3 shows a side view of one further exemplary embodiment of a LIDAR sensor, in accordance with the present invention.

FIG. 4A shows a first exemplary embodiment of the beam exit of the plate-shaped light guide optics and the beam entrance of two optical fibers, in accordance with the present invention.

FIG. 4B shows a second exemplary embodiment of the beam exit of the plate-shaped light guide optics and the beam entrance of two optical fibers, in accordance with the present invention.

FIG. 5 shows a top view of one further exemplary embodiment of a LIDAR sensor, in accordance with the present invention.

FIG. 6 shows a top view of one further exemplary embodiment of a LIDAR sensor, in accordance with the present invention.

FIG. 7 shows an exemplary embodiment of a method for optically detecting a field of view with the aid of a LIDAR sensor, in accordance with the present invention.

### DETAILED DESCRIPTION OF EXAMPLE EMBODIMENTS

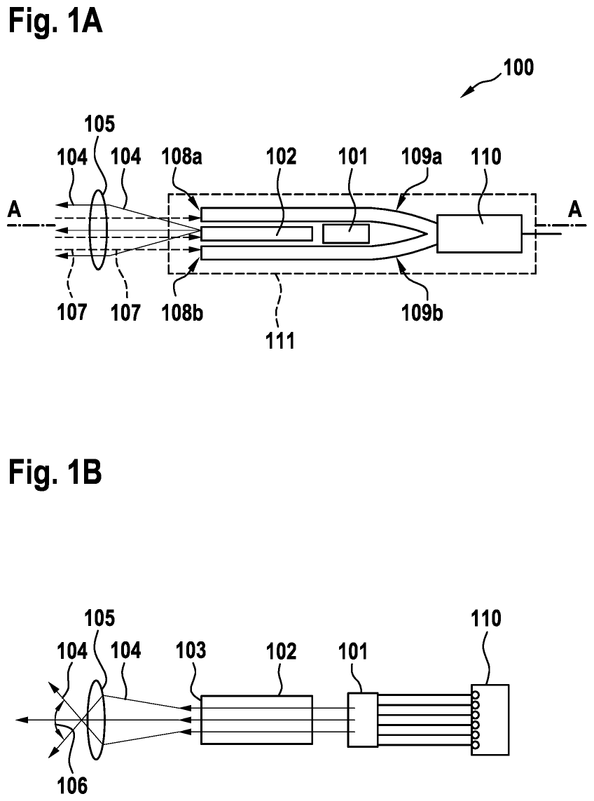

FIG. 1A shows, by way of example, a first exemplary embodiment of a LIDAR sensor 100 in the top view. The LIDAR sensor includes an emission unit for emitting primary light 104 into a field of view and a receiving unit for receiving secondary light 107, which was reflected and/or scattered in the field of view by an object. Here, the emission unit includes a light source 101 for generating primary light 104, a plate-shaped light guide optics 102 including a beam exit 103 for guiding generated primary light 104, and emission optics 105, which is designed here as an optical lens 105, for emitting guided primary light 104 into the field of view. The plate-shaped light guide optics 102 is designed for guiding primary light 104 generated by light source 101 to beam exit 103. Beam exit 103 is located in the imaging plane of emission optics 105. The receiving unit includes a receiving optics 105, which is designed here as an optical lens 105, for receiving secondary light 107. Emission optics 105 and receiving optics 105 are situated coaxially to one another. The emission optics and the receiving optics include, in the example, optical lens 105 as a shared optical element. The receiving unit also includes two optical fibers 109-a, 109-b, which each include a beam entrance 108-a, 108-b for guiding received secondary light 107, and a detector unit 110 for detecting guided secondary light 107. Optical fibers 109-a, 109-b are designed for guiding received secondary light 107 to detector unit 110. In the exemplary embodiment shown, plate-shaped light guide optics 102 and the two optical fibers 109-a, 109-b are situated symmetrically with respect to one another. Plate-shaped light guide optics 102 is situated between the two optical fibers 109-a, 109-b. Beam exit 103 of plate-shaped light guide optics 102 and beam entrance 108-a, 108-b of the two optical fibers 109-a, 109-b are situated so closely to one another in this case that they are largely uniformly illuminated due to the imaging quality of emission and receiving optics 105.

FIG. 1B shows a side view of the exemplary embodiment from FIG. 1A. Here, the side view represents section A-A marked in FIG. 1A. Marked angular range 106 represents a first angular range of the field of view. This may be, for example, the vertical angular range of the field of view of LIDAR sensor 100.

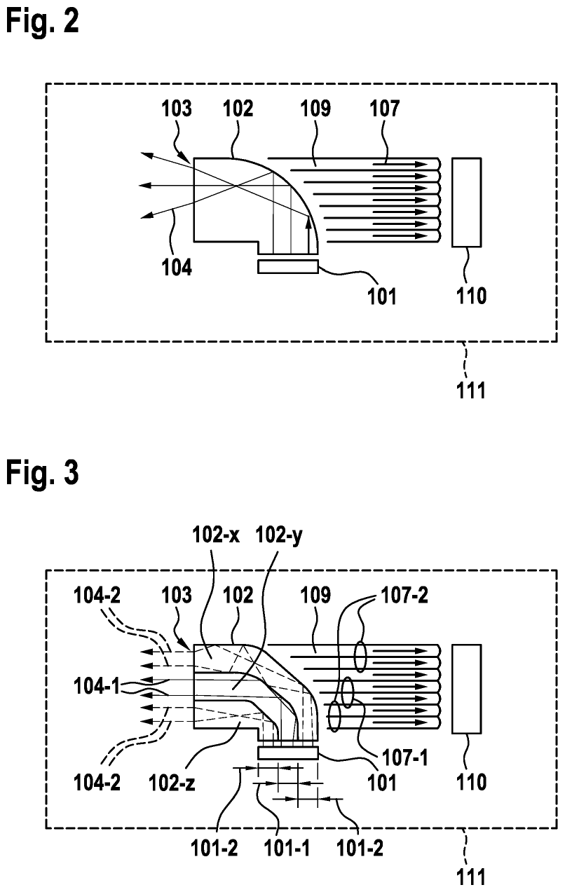

FIG. 2 shows a side view of one further exemplary embodiment of a LIDAR sensor. Various components of the LIDAR sensor, such as, for example, the emission optics and the receiving optics, are not shown, for the sake of clarity. The area of the LIDAR sensor shown in FIG. 2 is similar, with respect to its configuration, to area 111 in FIG. 1A. In FIG. 2, plate-shaped light guide optics 102 is designed in such a way that generated primary light 104 is mixable. For this purpose, plate-shaped light guide optics 102 is designed, for example, to be curved.

FIG. 3 shows a side view of one further exemplary embodiment of a LIDAR sensor. Various components of the LIDAR sensor, such as, for example, the emission optics and the receiving optics, are not shown, for the sake of clarity. The area of the LIDAR sensor shown in FIG. 3 is similar, with respect to its configuration, to area 111 in FIG. 1A. Light source 101 has various areas 101-1, 101-2, which primary light 104 having different optical properties 104-1, 104-2 may generate. An optical property of this type may be, for example, wavelength 104-1, 104-2 of the primary light. Generated primary light 104 of at least two wavelengths 104-1, 104-2, which differ from one another, is guidable to beam exit 103 with the aid of plate-shaped light guide optics 102. For this purpose, plate-shaped light guide optics 102 in the exemplary embodiment is designed to be curved. In addition, plate-shaped light guide optics 102 includes subareas 102-x, 102-y, 102-z situated separately from one another. Primary light 104 of at least two wavelengths 104-1, 104-2, which differ from one another, are mixable in subareas 102-x, 102-y, 102-z of plate-shaped light guide optics 102. Received secondary light then also has various wavelengths 107-1, 107-2. The received secondary light of various wavelengths 107-1, 107-2 is guided to detector unit 110 with the aid of at least two optical fibers and is detected by the detector unit, for example, with the aid of various areas, which are selective for different wavelengths.

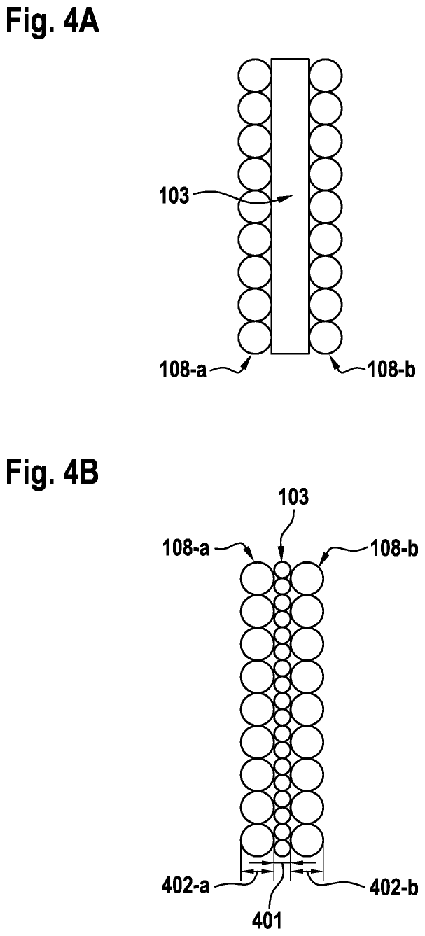

FIG. 4A shows a first exemplary embodiment of beam exit 103 of a plate-shaped light guide optics and beam entrance 108-a, 108-b of two optical fibers of the type represented in the preceding figures. FIG. 4B shows a second exemplary embodiment. Here, the area of beam exit 103 of the plate-shaped light guide optics is also designed as a fiber row. Surface portion 401 for beam exit 103 of the plate-shaped light guide optics is considerably smaller than surface portions 402-a, 402-b of beam entrances 108-a, 108-b; for example, surface portion 401 may be 10%, [and] surface portions 402-1, 402-b may each be 40%. As a result, little secondary light is lost in the receiving unit.

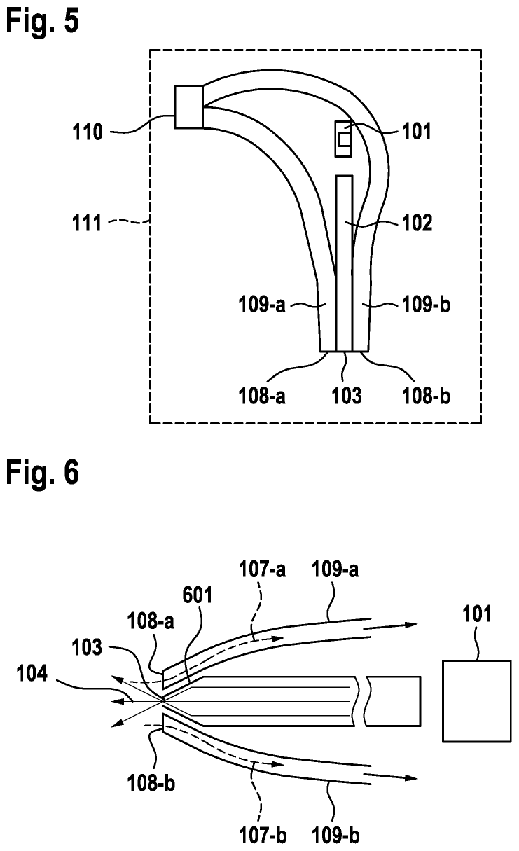

FIG. 5 shows a top view of one further exemplary embodiment of a LIDAR sensor. Various components of the LIDAR sensor, such as, for example, the emission optics and the receiving optics, are not shown, for the sake of clarity. The area of the LIDAR sensor shown in FIG. 5 is similar, with respect to its configuration, to area 111 in FIG. 1A. In FIG. 5 it is clearly apparent that the two optical fibers 109-a, 109-b are situated in a curved manner. Light source 101 and detector unit 110 are considerably distant from each other, i.e., not situated on one axis.

FIG. 6 shows a top view of one further exemplary embodiment of a LIDAR sensor. Various components of the LIDAR sensor, such as, for example, the emission optics and the receiving optics, and detector unit 110, are not shown, for the sake of clarity. In FIG. 6, the beam exit 103 of plate-shaped light guide optics 102 has a taper 601.

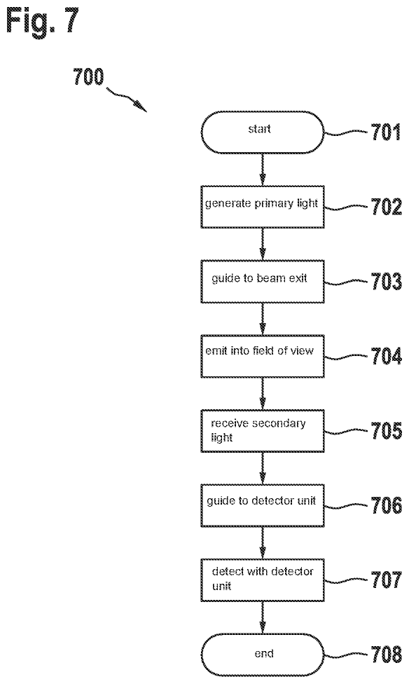

FIG. 7 shows one exemplary embodiment of a method 700 for optically detecting a field of view with the aid of a LIDAR sensor of the type described in FIGS. 1 through 6. The LIDAR sensor therefore includes an emitting unit for emitting primary light into the field of view and a receiving unit for receiving secondary light, which was reflected and/or scattered in the field of view by an object. Method 700 starts in step 701. In step 702, primary light is generated with the aid of a light source. In step 703, the generated primary light is guided to the beam exit with the aid of a plate-shaped light guide optics including a beam exit. In step 704, the guided primary light is emitted into the field of view with the aid of at least one emission optics. In step 705, secondary light is received with the aid of at least one receiving optics. In step 706, the received secondary light is guided to at least one detector unit with the aid of at least two optical fibers, each of which includes one beam entrance. In step 707, the guided secondary light is detected with the aid of the detector unit. The emission optics and the receiving optics are situated coaxially to one another here. Method 700 ends in step 708.

1-10. (canceled)

11. A LIDAR sensor for optically detecting a field of view, comprising:
an emission unit configured to emit primary light into the field of view; and
a receiving unit configured to receive secondary light, which was reflected and/or scattered in the field of view by an object;
wherein the emission unit includes:
a light source configured to generate the primary light,
a plate-shaped light guide optics including a beam exit configured to guide the generated primary light, and
at least one emission optics configured to emit the guided primary light into the field of view;
wherein the receiving unit includes:
at least one receiving optics configured to receive secondary light,
at least two optical fibers, which each have a beam entrance, for guiding the received secondary light, and
at least one detector unit configured to detect the guided secondary light; and
wherein the emission optics and the receiving optics are situated coaxially to one another.

12. The LIDAR sensor as recited in claim 11, wherein the plate-shaped light guide optics include at least one fiber bundle.

13. The LIDAR sensor as recited in claim 11, wherein the at least two optical fibers are situated in a curved manner.

14. The LIDAR sensor as recited in claim 11, wherein the plate-shaped light guide optics is designed in such a way that the generated primary light is mixable.

15. The LIDAR sensor as recited in claim 14, wherein the generated primary light is mixable in at least two subareas of the plate-shaped light guide optics, which are situated separately from one another.

16. The LIDAR sensor as recited in claim 15, wherein generated primary light of at least two wavelengths, which differ from one another, is guidable to the beam exit using the plate-shaped light guide optics.

17. The LIDAR sensor as recited in claim 11, wherein the beam exit of the plate-shaped light guide optics has a taper.

18. The LIDAR sensor as recited in claim 11, wherein the beam exit of the plate-shaped light guide optics is a rod lens structure.

19. The LIDAR sensor as recited in claim 11, wherein a refractive index of the plate-shaped light guide optics is smaller than a refractive index of the at least two optical fibers.

20. A method for optically detecting a field of view using a LIDAR sensor, the LIDAR sensor including an emission unit configured to emit primary light into the field of view and a receiving unit configured to receive secondary light, which was reflected and/or scattered in the field of view by an object, the method including the following steps:
generating the primary light using a light source;
guiding the generated primary light using a plate-shaped light guide optics including a beam exit;
emitting the guided primary light into the field of view using at least one emission optics;
receiving secondary light using at least one receiving optics;
guiding the received secondary light using at least two optical fibers, each of which including a beam entrance; and
detecting the guided secondary light using at least one detector unit;
wherein the emission optics and the receiving optics are situated coaxially to one another.
